(19) United States
(12) Patent Application Publication
(10) Pub. No.: US 2016/0313938 A1
(43) Pub. Date: Oct. 27, 2016

(54) FINE GRAINED MEMORY PROTECTION TO THWART MEMORY OVERRUN ATTACKS

(71) Applicant: QUALCOMM Incorporated, San Diego, CA (US)

(72) Inventors: Alexander Gantman, Solana Beach, CA (US); Can Acar, San Diego, CA (US); Billy Brumley, San Diego, CA (US); Brian Rosenberg, San Diego, CA (US)

(21) Appl. No.: 14/696,229

(22) Filed: Apr. 24, 2015

(51) Int. Cl. G06F 3/06

(52) U.S. Cl. CPC G06F 3/0622; G06F 3/0637; G06F 3/0673

(57) ABSTRACT

A way is provided to protect memory blocks from unauthorized access from executable instructions by defining various sets of instructions that are specifically bound to operate on defined memory blocks and inhibited from operating in other memory blocks. For instance, executable code may include a plurality of distinct read and write instructions where each read and/or write instruction is specific to one memory access tag from a plurality of different memory access tags. Memory blocks are also established and each memory block is associated with one of the plurality of different memory access tags. Consequently, if a first read and/or write instruction, associated with a first memory access tag, attempts to access a memory block associated with a different memory access tag, then execution of the first read and/or write instruction is inhibited or aborted.

### FIELD

Various features disclosed herein pertain generally to methods for mitigating memory overrun attacks, and more particularly, to a method in which executable instructions and memory blocks are associated with tags so that instructions can only access memory blocks (e.g., sub-page size memory blocks) if both of their tags are the same.

### BACKGROUND

Devices, such as mobile phones, mobile devices, pagers, wireless modems, personal digital assistants, tablets, personal information managers (PIMs), personal media players, palmtop computers, laptop computers, or any other device with a processor are becoming increasingly popular and ubiquitous. Data generated, entered, stored, and/or received at such devices should be secured against unauthorized access. One such risk of unauthorized access includes a memory overrun attack that makes use of existing read or write operations in executable code to compromise information in a device. The overrun memory attack typically involves modifying some register(s) (e.g., address register, pointer register, etc.) which results in a read or write (in executable code or instructions) to access an unintended portion of memory in order to create a memory overrun.

Consequently, there is a need for a solution that prevents or inhibits overrun memory attacks.

### SUMMARY

A first feature provides a method for compiling executable code with integrated memory block protection. A plurality of memory access tags may be defined. In one example, the plurality of memory access tags may include three or more distinct types of memory access tags. Likewise, a plurality of read and write instructions may be defined that are specific to each memory access tag. For instance, each read and/or write instruction, in the plurality of read and/or write instructions, may be associated with a distinct memory access tag.

During compilation of a source code to an executable code, one or more memory blocks for the plurality of read and/or write instructions may be defined. In some implementations, a memory block may be a sub-page size memory region.

One or more memory blocks may be associated with a corresponding memory access tag. Each memory block is only accessible by a read and/or write instruction associated with a same corresponding memory access tag.

In one example, the plurality of memory access tags may include three or more distinct types of memory access tags.

According to one example, defining the plurality of distinct read and write instructions may include: (a) defining a first read and/or write instruction associated with a first memory access tag; (b) defining a second read and/or write instruction associated with a second memory access tag, wherein the first read and/or write instruction fails to operate on a memory block associated with the second access tag. The first memory access tag may be associated with a plurality of memory blocks.

In one implementation, the one or more memory blocks may be defined within a memory stack region or a memory heap region.

A second features provides a non-transitory machine-readable storage medium having one or more instructions which when executed by a processing circuit causes the processing circuit to: (a) define a plurality of memory access tags; (b) define a plurality of read and write instructions that are specific to each memory access tag; and/or (c) define, during compilation of a source code to an executable code, one or more memory blocks for the plurality of read and/or write instructions and associating one or more memory blocks with a corresponding memory access tag, where each memory block is only accessible by a read and/or write instruction associated with a same corresponding memory access tag. In some examples, each memory block may be a sub-page size memory region.

A third feature provides a method operational at a processing device for protecting memory blocks on a per-instruction basis. An executable code is obtained from a storage device, the executable code including a plurality of distinct read and write instructions where each read and/or write instruction is associated with one memory access tag from a plurality of distinct memory access tags. One or more memory blocks may be define in which each memory block is associated with one of the plurality of distinct memory access tags. In one example, the executable code may be a single application or process

At least some of the plurality of distinct read and/or write instructions in the executable code may then be executed (or loaded for execution), where each executed read and/or write instruction is restricted to only access a memory block associated with the same memory access tag as the executed read and/or write instruction. That is, if a read and/or write instruction attempts to access a memory block associated with a different memory access tag than the read and/or write instruction, then execution of the read and/or write instruction is inhibited or aborted.

In one example, the plurality of distinct read and write instructions may include: (a) a first read and/or write instruction associated with a first memory access tag; (b) a second read and/or write instruction associated with a second memory access tag. The first read and/or write instruction is inhibited or aborted if it attempts to access a memory block associated with the second access tag.

The one or more memory blocks may be pre-defined when the executable is compiled or may be dynamically defined when the executable code is executed.

A fourth feature provides a device configured to protect memory blocks on a per-instruction basis. The device may include a storage device and a processing circuit. The storage device may store an executable code, the executable code including a plurality of distinct read and write instructions where each read and/or write instruction is associated with one memory access tag from a plurality of distinct memory access tags. The processing circuit may be configured to: (a) define one or more memory blocks in which each memory block is associated with one of the plurality of distinct memory access tags; (b) execute at least some of the plurality of distinct read and/or write instructions in the executable code, and/or (c) where each executed read and/or write instruction is restricted to only access a memory block associated with the same memory access tag as the executed read and/or write instruction.

In another instance, the device may include: (a) means for obtaining an executable code from a storage device, the executable code including a plurality of distinct read and write instructions where each read and/or write instruction is associated with one memory access tag from a plurality of distinct memory access tags; (b) means for defining one or more memory blocks in which each memory block is associated with one of the plurality of distinct memory access tags; and/or (c) means for executing at least some of the plurality of distinct read and/or write instructions in the executable code, where each executed read and/or write instruction is restricted to only access a memory block associated with the same memory access tag as the executed read and/or write instruction.

In yet another instance, a non-transitory machine-readable storage medium is provided having one or more instructions which when executed by a processing circuit causes the processing circuit to: (a) obtain executable code from a storage device, the executable code including a plurality of distinct read and write instructions where each read and/or write instruction is associated with one memory access tag from a plurality of distinct memory access tags; (b) define one or more memory blocks in which each memory block is associated with one of the plurality of distinct memory access tags; and/or (c) execute at least some of the plurality of distinct read and/or write instructions in the executable code, where each executed read and/or write instruction is restricted to only access a memory block associated with the same memory access tag as the executed read and/or write instruction.

A fifth feature provides another method operational at a processing device for protecting memory blocks on a per-instruction basis. An executable code may be obtained from a storage device, the executable code including a plurality of distinct read and write instructions where each read and/or write instruction is specific to one memory access tag from a plurality of different memory access tags. A first read and/or write instruction associated with a first memory access tag may be obtained from the executable code. Execution of the first read and/or write instruction is inhibited, aborted, or blocked if the first read and/or write instruction attempts to access a memory block associated with a different memory access tag. In some instances, a memory block may be a sub-page size memory region. A mapping may be maintained that defines a memory access tag for each of a plurality of memory blocks.

In one example, the plurality of different memory access tags may include three or more distinct types of memory access tags. The first memory access tag may be associated with a plurality of distinct memory blocks.

A sixth feature provides a device configured to protect memory blocks on a per-instruction basis. The device may include a storage device and a processing circuit. The storage device may store an executable code, the executable code including a plurality of distinct read and write instructions where each read and/or write instruction is specific to one memory access tag from a plurality of different memory access tags. A processing circuit may be configured to: (a) obtain, from the executable code, a first read and/or write instruction associated with a first memory access tag; and/or (b) inhibit execution of the first read and/or write instruction if the first read and/or write instruction attempts to access a memory block associated with a different memory access tag.

In another instance, the device may comprise: (a) means for obtaining an executable code from a storage device, the executable code including a plurality of distinct read and write instructions where each read and/or write instruction is specific to one memory access tag from a plurality of different memory access tags; (b) means for obtaining, from the executable code, a first read and/or write instruction associated with a first memory access tag; and/or (c) means for inhibiting execution of the first read and/or write instruction if the first read and/or write instruction attempts to access a memory block associated with a different memory access tag.

In yet another example, a non-transitory machine-readable storage medium is provided for protecting memory blocks from unauthorized access, the machine-readable storage medium having one or more instructions which when executed by a processing circuit causes the processing circuit to: (a) obtain executable code from a storage device, the executable code including a plurality of distinct read and write instructions where each read and/or write instruction is specific to one memory access tag from a plurality of different memory access tags; (b) obtain, from the executable code, a first read and/or write instruction associated with a first memory access tag; and/or (c) inhibit execution of the first read and/or write instruction if the first read and/or write instruction attempts to access a memory block associated with a different memory access tag.

### BRIEF DESCRIPTION OF THE DRAWINGS

FIG. 1 is a block diagram illustrating an exemplary operating environment for a method of protecting memory blocks from authorized access.

FIG. 2 illustrate how memory blocks may be tagged or associated with one of a plurality of different memory access tags.

FIG. 3 is a block diagram illustrating an exemplary system in which memory blocks are protected from authorized access on a per-instruction and per memory block basis.

FIG. 4 is a flow diagram illustrating a method that may be implemented by a compiler to provide per instruction memory block protection.

FIG. 5 is a flow diagram illustrating a second method to provide per instruction memory block protection.

FIG. 6 is a flow diagram illustrating a second method to provide per instruction memory block protection.

FIG. 7 is a block diagram illustrating an exemplary processing device configured to execute code while providing per instruction memory block protection.

### DETAILED DESCRIPTION

In the following description, specific details are given to provide a thorough understanding of the described implementations. However, it will be understood by one of ordinary skill in the art that the implementations may be practiced without these specific details. For example, circuits may be shown in block diagrams in order not to obscure the implementations in unnecessary detail. In other instances, well-known circuits, structures and techniques may be shown in detail in order not to obscure the implementations.

The word “exemplary” is used herein to mean “serving as an example, instance, or illustration.” Any implementation or embodiment described herein as “exemplary” is not necessarily to be construed as preferred or advantageous over other embodiments or implementations.

### Overview

One feature provides a way to protecting memory blocks from unauthorized access. For instance, prior to compilation or concurrent with generation of an executable code, a plurality of different memory access tags are defined. Likewise, a plurality of distinct read and write instructions are defined that are specific to each memory access tag. A read and/or write instruction fails to execute (or is prevented from executing) if it is applied to memory blocks associated with a different memory access tag. During compilation of executable code, memory blocks are associated with one of the plurality of access attributes.

According to a second aspect, during execution of the executable code, a processing circuit may ascertain a memory access tag for a first read and/or write instruction. Execution of a first read and/or write instruction associated with a first memory access tag is inhibited, blocked, and/or aborted if the first read and/or write instruction is applied to a memory block associated with a second memory access tag.

According to a third aspect, protection of memory blocks is achieved independent of having the processing circuit or operating system establish any application-dependent or user-dependent security contexts or protected memory regions. That is, the instructions used in compiling the executable code define the memory space (e.g., tagged memory region) that is accessible by such instruction. The processing circuit executing such instructions merely follows the execution rules/protocol established by such instructions. Consequently, an instruction is only allowed to access a memory region if both are associated with the same memory access tag. This approach is independent of any other memory protection mechanism or method that may be implemented by a processor and/or operating system to secure or protect certain memory regions from being accessed by certain applications.

According to a fourth aspect, protection of memory blocks may be independent of the application(s). That is, memory blocks may be protected on a per-instruction basis rather than on a per application basis. Consequently, different read or write instructions from within the same application may not be able to access the same memory block(s). For instance, a first read or write instruction associated with a first memory access tag may be able to access a first memory block that is also associated with the first memory access tag, but a second read or write instruction associated with a second memory access tag (or not associated with the first memory access tag) is not allowed to access the first memory block even when both the first read or write instruction and the second read or write instruction originate from within the same executing application.

According to a fifth aspect, protection of the memory blocks is implemented in sub-page sized memory blocks. The memory block size is smaller than whatever memory page size is being used by a particular system architecture to allocate memory to different applications and/or processes.

According to a sixth aspect, a memory access tag attribute is added to define a characteristic of a memory block. This memory access tag is distinct from other attributes, such as read attribute, write attribute, etc.

### Exemplary Operating Environment

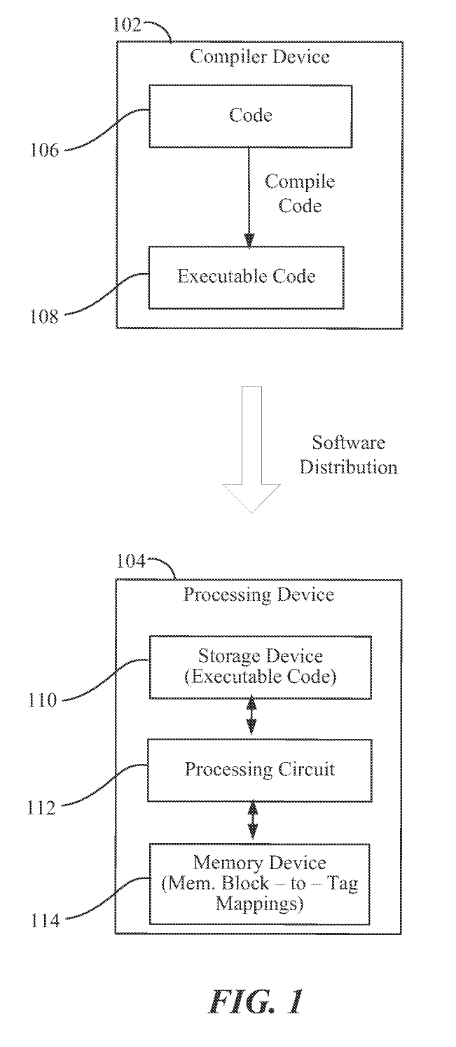

FIG. 1 is a block diagram illustrating an exemplary operating environment for a method of protecting memory blocks from authorized access (e.g., by overrun memory attacks). For instance, a code 106 maybe compiled into an executable code 108 by a compiler device 102. In compiling the code, the compiler device 102 may associate each memory block used/defined by the code (e.g., for storage of data and/or instructions) with a memory access tag from among a plurality of different memory access tags. Note that the memory access tags may be unrelated to secure versus non-secure memory allocations (e.g., of memory pages and/or memory blocks). Instead, the memory access tags may be logical constructs with which to reference one or more memory blocks and distinguish them from other memory blocks. Likewise, a plurality of distinct types read and/or write instructions may be used in the executable code, where each type of read and/or write instruction is associated with a distinct memory access tag. In various examples, a “tag” may be any identifier, mapping, and/or attribute (e.g., that are explicit, implicit, and/or logical) that may serve to relate or associate a memory block with a specific executable instruction (e.g., read and/or write instruction). For instance, different sets of read/write instructions may be defined that perform the same read/write operation, but each is specific to, and/or bound to, a particular memory block (or memory access tag) from a plurality of different memory blocks.

In some implementations, protection of the memory blocks may be implemented in sub-page sized memory blocks. A memory page, also referred to as a “page” or a “virtual page”, may be a fixed-length contiguous block of memory and is often described by a single entry in a page table. Memory pages are often associated or allocated to processes or application executed by a processing circuit. A page table is often used to define or track the memory pages allocated and/or assigned to each process or application. In some instances, a memory page may be the smallest unit of data for memory management in a memory operating system. The memory block size is smaller than whatever memory page size is being used by a particular system architecture (e.g., processing circuit, memory manage circuit, etc.) to allocate memory to different applications and/or processes.

The executable code may be loaded into a storage device 110 of a processing device 104. A processing circuit 112 within the processing device 104 may then execute the executable code in which read and/or write instructions, associated with a first memory access tag, can only access memory blocks associated with the same first memory access tag. A mapping of memory block to memory access tags may be maintained for this purpose within a memory device 114.

Exemplary Protection of Memory Blocks from Unauthorized Access

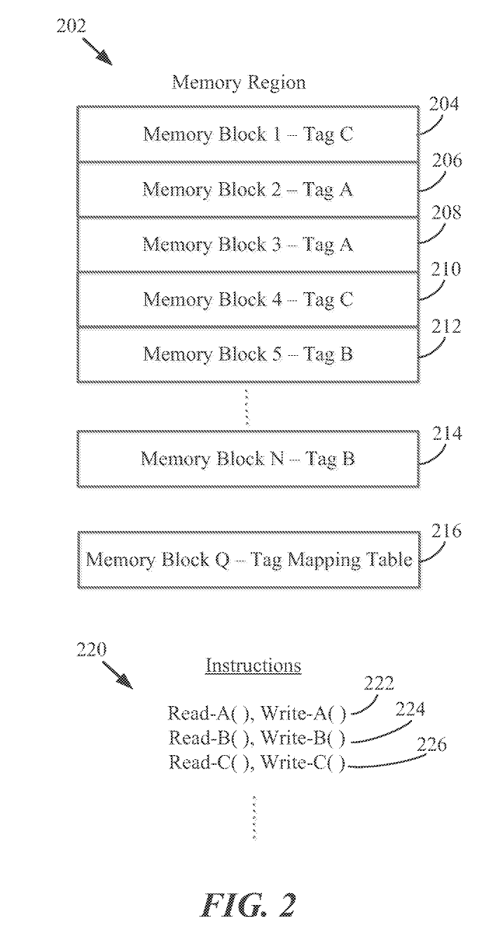

FIG. 2 illustrate how memory blocks may be tagged or associated with one of a plurality of different memory access tags. When an executable code is compiled, memory blocks may be defined for variables, registers, etc. The compiler ascertains which read/write instructions should have access to which memory blocks. Consequently, read/write instructions are associated and/or restricted to operate on only the memory blocks for which they are intended. This prevents an unrelated read/write instruction from being used to access an unintended memory block as part of a memory overrun attack.

In one example, a memory region 202 may be logically divided or arranged as memory blocks 204, 206, 208, 210, 212, and 214. Each memory block may be, for example, sub-page memory segments (e.g., smaller than a memory page size). Each memory block is associated with a tag that is maintained in a mapping table 216.

For each memory access tag, a different set of read and write instructions 220 or commands may be defined. For example, for a tag-A, instructions Read-A and Write-A 222 are defined, for Tag-B, instructions Read-B and Write-B 224 are defined, and for Tag-C, instructions Read-C and Write-C 226 are defined. These instructions 220 specifically check whether they are accessing a memory block that is tagged or associated with their corresponding access attribute. These instructions 220 only proceed or execute if the memory block which they are to access is identified/tagged with their corresponding access attribute. For example, if the Write-A instruction is invoked to write or store data in a memory block tagged with Tag-B, then the Write-A instruction fails and does not proceed. The Read and Write operations may also be called Load and Store operations in some implementations. Additionally, other instructions specific to each access tag may be defined in some implementations. The tag for the memory blocks may be stored in a memory block to tag mapping table 216.

Under intended operation, a read/write instruction would only be able to access a memory block to which it is originally allocated. However, in a memory overrun attack, a read/write instruction may be repurposed by an attacker to access an unintended memory block. The use of memory access tags illustrated herein prevents such unintended access to memory blocks by using tags to bind particular read/write instructions to only the memory blocks to which they were originally intended.

Upon compiling source code to executable code, the compiler may be configured to identify which source code read and/or write instructions should have access to which memory blocks and then uses distinct read and/or write instructions (e.g., distinct classes and/or types of instructions) for each distinct memory block(s) identified. For instance, each memory block identified may be associated with a distinct memory access tag. Likewise, the instruction(s) that is allowed to access a particular memory block is also associated with the same memory access tag as the particular memory block. In this manner, the executable code (or instruction therein) are restricted to operate on only pre-determined or pre-associated memory blocks. If an instruction attempts to access a memory block that is not associated with the instruction, then execution of such instruction is aborted by the processing circuit. In one implementation, access to the memory blocks is restricted on a per instruction basis, such that only a single read and/or write instruction (from among a plurality of distinct read and/or write instructions) is allowed to access each memory block. Additionally, no single (read/write) instruction is permitted to access all memory blocks (e.g., memory blocks with which the single instruction is not explicitly associated).

In one example, each 8-word block of memory may be marked or tagged as either protected or unprotected (e.g., a two-tag approach). Separate loadiread and store/write instructions are defined for accessing protected and unprotected memory. In an exemplary implementation, protected regions may be used as “guard” blocks between unprotected regions of memory. When a process is accessing unprotected memory in a loop, if it goes past the end of the unprotected block and attempts to access a protected block, the instruction will fail as the memory access attribute (protected) no longer matches the access instructions (associated with unprotected). Similarly, a process operating on protected memory cannot go past an adjacent unprotected memory block.

In a more complex deployment, protected blocks can also be used to store metadata or control flow data. For example, on the stack, the compiler can place a stack pointer and a return address (as well as other saved registers) into a protected block, making it more difficult for them to become overwritten. Similarly, on the heap, heap metadata can be placed in protected blocks. The method may be fully backwards compatible with existing code (e.g., by simply marking everything as unprotected).

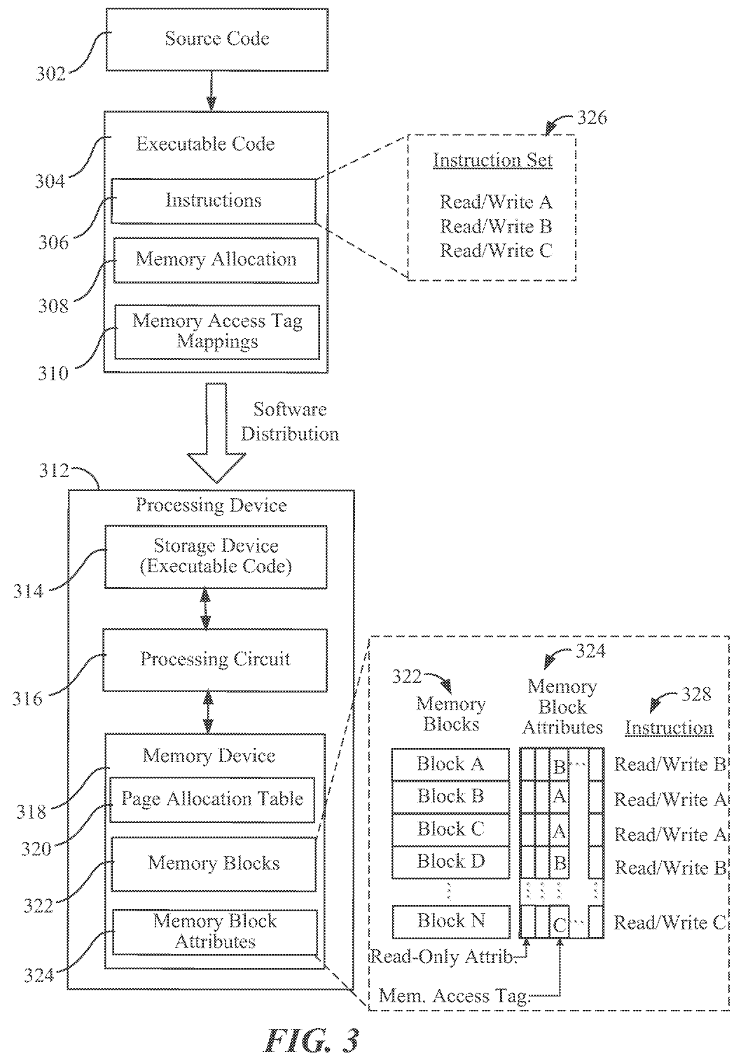

FIG. 3 is a block diagram illustrating an exemplary system in which memory blocks are protected from authorized access on a per instruction and per memory block basis. For example, a source code 302 maybe compiled into an executable code 304 by a compiler device. In compiling the source code 302, the compiler device create executable instructions 306, memory allocations 308, and/or memory access tags mappings 310. In one example, the instructions 306 may include distinct instructions 326 that may perform some of the same operations (e.g., Read/Write A, Read/Write B, Read/Write C, etc.). However, each of the distinct instructions may be explicitly bound to memory blocks. For instance, the executable code 304 may define or associate each memory block used by the instructions 306 (e.g., for storage of data and/or instructions) with a memory access tag from among a plurality of different memory access tags. Each instruction 326 may be associated with a different memory access tag so that only those instructions having the same memory access tag as a particular memory block is permitted to access that memory block. For instance the Read-A and/or Write-A instruction may be associated with a first memory access tag A while the Read-B and/or Write-B instruction may be associated with a second memory access tag B.

Upon distribution to a processing device 312, the executable code 304 may be stored in a storage device 314 from which it may be executed by a processing circuit 316. In various examples, the processing circuit 316 may include one more processors, memory controller, input/output interfaces, etc. A memory device 318 may also be coupled to the processing device 312. In one example, the processing circuit may setup a page allocation table 320 in the memory device 318 that allocates memory pages on a per application and/or process basis. The executable code 304 may also cause the processing circuit 316 to setup memory blocks 322 and memory block attributes 324 in the memory device 318 on a per instruction basis.

In one example, for each memory block 322 (e.g., Block A, Block B, . . . , Block N), a set of memory block attributes 324 is defined. The set of attributes 324 may include, for example, a read-only attribute, a memory access tag attribute, etc. The read-only attribute may define whether a corresponding memory block is read-only by a particular application and/or process. The memory access tag attribute may indicate which calling instruction is allowed to read and/or write to the corresponding memory block. In this manner, each memory block is bound to a particular instruction 328 and cannot be accessed by instructions associated with other memory access tags.

Note that the memory access tags may be unrelated to secure versus non-secure memory allocations (e.g., of memory pages and/or memory blocks). Instead, the memory access tags may be logical constructs with which to reference one or more memory blocks and distinguish them from other memory blocks. Likewise, a plurality of distinct types read and/or write instructions may be used in the executable code, where each type of read and/or write instruction is associated with a distinct memory access tag.

In one example, protection of the memory blocks is implemented in sub-page sized memory blocks. The memory block size is smaller than whatever memory page size is being used by page allocation table 320 to allocate memory to different applications and/or processes.

Additionally, the use of memory access tags to bind memory blocks and instructions may be independent of having the processing device 312 (or operating system executed therein) establish any application-dependent or user-dependent security contexts or protected memory regions. That is, an executable instruction is only allowed to access a memory block if both that instruction and the memory block are associated with the same memory access tag. In this manner, memory blocks 322 may be protected on a per-instruction basis rather than on a per application basis. Consequently, different read or write instructions from within the same application/process may not be able to access the same memory block(s). For instance, a first read or write instruction (e.g., Read/Write A) associated with a first memory access tag (e.g., tag A) may be able to access a first memory block (e.g., Block C) that is also associated with the first memory access tag (e.g., tag A). But a second read or write instruction (e.g., Read/Write B) associated with a second memory access tag (e.g., tag B), or not associated with the first memory access tag (e.g., tag A), is not allowed to access the first memory block (e.g., Block C) even when both the first read or write instruction (e.g., Read/Write A) and the second read or write instruction (e.g., Read/Write B) originate from within the same executing application or process.

### Exemplary Compiler

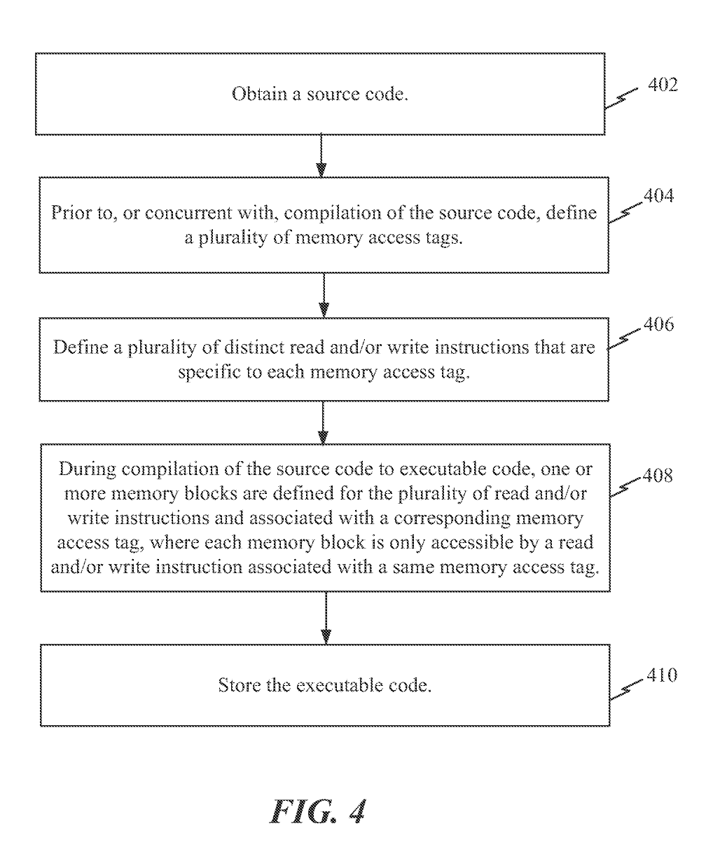

FIG. 4 is a flow diagram illustrating a method that may be implemented by a compiler to provide per instruction memory block protection. A source code is obtained 402. Prior to, or concurrent with, compilation of the source code, a plurality of memory access tags may be defined 404 (e.g., generated, computed, etc.). A plurality of read and/or write instructions are defined that are specific to each memory access tag 406. For instance, each read and/or write instruction, in the plurality of read and/or write instructions, may be associated with a distinct memory access tag.

During compilation of the source code to an executable code, one or more memory blocks are defined for the plurality of read and/or write instructions and associated with a corresponding memory access tag, where each memory block is only accessible by a read and/or write instruction associated with a same corresponding memory access tag 408. For example, if a memory block is associated with a first memory access tag, it can only be accessed (e.g., read from or written to) by an instruction (e.g., read/write instructions) that is also associated with the first memory access tag. That is, an instruction is prevented from executing (e.g., performing read or write operations) if applied to a memory block associated with a different memory access tag than the instruction. Each read and/or write instruction, in the plurality of read and/or write instructions, may be associated with a distinct memory access tag. The plurality of read and/or write instructions may be used in generating the executable code from the source code.

In an alternative implementation, rather than the compiler defining the one or more memory blocks, the one or more memory blocks may be dynamically defined and/or established upon execution of the executable code (e.g., by a processing circuit).

In one implementation, while compiling the source code into the executable code, the compiler may be configured to identify which source code read and/or write instructions should have access to which memory blocks. Then, distinct read and/or write instructions (e.g., distinct classes and/or types of instructions) are used for each distinct memory block(s) identified. As previously noted, each memory block identified may be associated with a distinct memory access tag. Likewise, the instruction(s) that is allowed to access a particular memory block is also associated with the same memory access tag as the particular memory block. In this manner, the executable code (or instruction therein) are restricted to operate on only pre-determined or pre-associated memory blocks.

The executable code may be stored 410 for distribution and/or transmission. The plurality of memory access tags may include three or more distinct types of memory access tags.

In one example, defining the plurality of distinct read and write instructions, may include defining a first read and/or write instruction associated with a first memory access tag and defining a second read and/or write instruction associated with a second memory access tag. The first read and/or write instruction fails to operate or is prevented from operating on a memory block associated with the second access tag, and vice versa.

In one example, each memory access tag may be associated with one or more different memory blocks.

A memory block may be a sub-page memory region (e.g., a block is smaller than a memory page size). Even when a first instruction (e.g., read A/write A) from a first application/process is able to access (e.g., read from/write to) a first memory block, a second distinct instruction (e.g., read B/write B) from the same first application/process but associated with a different memory access tag, is prevented from accessing the first memory block.

In various examples, the memory blocks may be defined within a memory stack region or a memory heap region.

Exemplary Execution of Code with Fine Grained Memory Protection

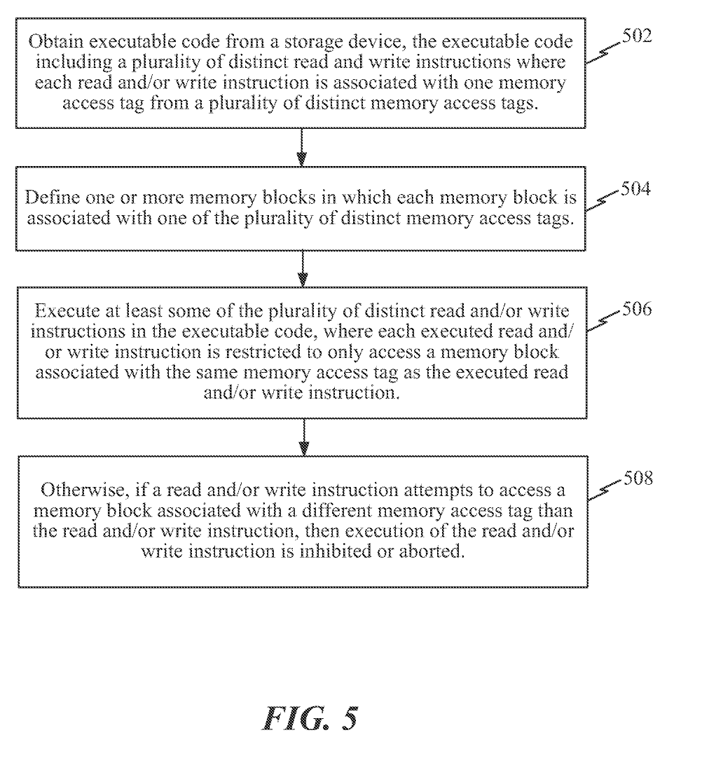

FIG. 5 is a flow diagram illustrating a first method to provide per instruction memory block protection. An executable code may be obtained from a storage device, the executable code including a plurality of distinct read and/or write instructions where each read and/or write instruction is associated to one memory access tag from a plurality of distinct memory access tags 502. In various examples, the plurality of distinct read and/or write instructions may be construed as distinct classes of read and/or write instructions, distinct types of read and/or write instructions, etc.

One or more memory blocks are then defined in which each memory block is associated with one of the plurality of distinct memory access tags 504. Such definition of memory blocks may be in accordance with the executable code (e.g., pre-defined by the executable code) or may be dynamically defined by a processing circuit upon execution of the executable code. Each memory block may be a sub-page size memory region (e.g., a block is smaller than a memory page).

At least some of the plurality of distinct read and/or write instructions in the executable code are executed, where each executed read and/or write instruction is restricted to only access a memory block associated with the same memory access tag as the executed read and/or write instruction 506. For instance, such restriction may be imposed by a processing circuit that executes the executable code. Prior to permitting access to a memory block, the processing circuit may verify (e.g., using attributes, a memory access tag mapping table, etc.) that an instruction seeking access to that memory block is associated with the same memory access tag as the memory block. Otherwise, if a read and/or write instruction attempts to access a memory block associated with a different memory access tag than the read and/or write instruction, then execution of the read and/or write instruction is inhibited or aborted 508.

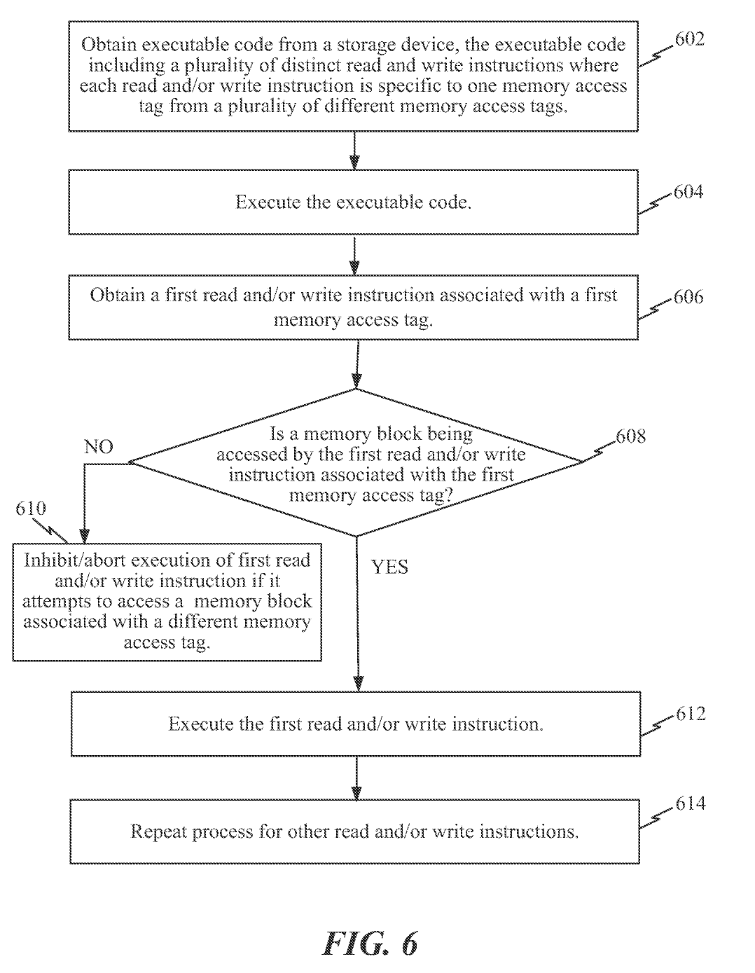

FIG. 6 is a flow diagram illustrating a second method to provide per instruction memory block protection. An executable code may be obtained from a storage device, the executable code including a plurality of distinct read and write instructions where each read and/or write instruction is specific to one memory access tag from a plurality of different memory access tags 602. In one example, the plurality of different memory access tags may include three or more distinct types of memory access tags. Such access memory tags may be distinct from, and/or different from, generic attributes such as the read-only attribute.

As part of executing the executable code 604, a first read and/or write instruction associated with a first memory access tag is obtained 606. The first memory access tag may be associated with a plurality of distinct memory blocks, where the plurality of distinct memory blocks are all associated with the same memory access tag. For example, the first plurality of distinct memory blocks may include a first subset of memory blocks and a second subset of memory blocks, where the first and second subset of memory blocks may be in a continuous or discontinuous memory region.

In some instances, a memory block may be a sub-page memory region. In some examples, after the first read and/or write instruction is obtained, a determination is made as to which memory access tag is associated with the first read and/or write instruction. A determination is made as to whether the memory block being accessed by the first read and/or write instruction is associated with the first memory access tag 608.

Execution of the first read and/or write instruction is inhibited or aborted if the first read and/or write instruction attempts to access a memory block associated with a different memory access tag 610 (than the first read and/or write instruction). For instance, it may be ascertained that the first read and/or write instruction seeks to access a memory block associated with a second memory access tag.

Otherwise, the first read and/or write instruction is executed 612. This process may be repeated for some or all of the instructions in the executable code 614.

A mapping may be maintained, in a memory device, which defines a memory access tag for each of a plurality of memory blocks.

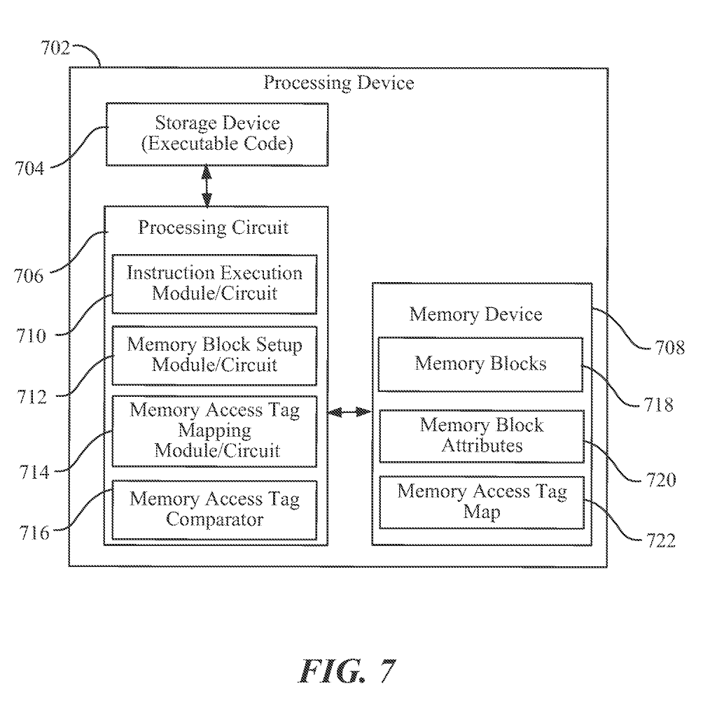

FIG. 7 is a block diagram illustrating an exemplary processing device configured to execute code while providing per instruction memory block protection.

The processing device 702 may include a storage device 704, a processing circuit 706, and/or a memory device 708.

The storage device 704 may serve to store executable code. The executable code may include a plurality of distinct read and write instructions where each read and/or write instruction is specific to one memory access tag from a plurality of different memory access tags.

The processing circuit 706 may include an instruction execution module/circuit 710, a memory block setup module/circuit 712, a memory access tag mapping module/circuit 714, and/or a memory access tag comparator 716. The instruction execution module/circuit 710 may serve to execute instructions defined by the executable code. The memory block setup module/circuit 712 may serve to establish memory blocks 718 (within the memory device 708) in accordance with the executable code. The memory access tag mapping module/circuit 714 may serve to map a memory block to a memory access tag. The memory access tag comparator 716 may serve to compare a memory access tag associated with an instruction to a memory access tag for a memory block being accessed.

The memory device 708 may include the memory blocks 718, memory block attributes 720 (e.g., which may define a memory access tag for each memory block), and/or a memory access tag map 722 to map memory access tags to memory blocks.

The modules/circuits in FIG. 7 may serve to implement one or more features described in FIGS. 5 and 6 (and elsewhere). For instance, the instruction execution module/circuit 710 may obtain, from the executable code, a first read and/or write instruction associated with a first memory access tag. The instruction execution module/circuit 710 may use the memory access tag mapping module/circuit 714 and/or the memory access tag comparator 716 to ascertain that: (a) the first read and/or write instruction is associated with the first memory access tag, or (b) the first read and/or write instruction seeks to access a memory block associated with a second memory access tag.

The instruction execution module/circuit 710 may inhibit execution of the first read and/or write instruction if the first read and/or write instruction attempts to access a memory block associated with a different memory access tag. In some implementations, a memory block is a sub-page size memory region.

One or more of the components, steps, features and/or functions illustrated in FIGS. 1, 2, 3, 4, 5, 6 and/or 7 may be rearranged and/or combined into a single component, step, feature or function or embodied in several components, steps, or functions. Additional elements, components, steps, and/or functions may also be added without departing from the scope of the present disclosure. The apparatus, devices and/or components illustrated in FIGS. 1, 3 and 7 may be configured to perform one or more of the methods, features, or steps described in FIGS. 2, 4, 5 and/or 6. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms non-transitory “machine-readable medium”, “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory (random access memory), flash memory, ROM memory (read-only memory), EPROM memory (erasable programmable read-only memory), EEPROM memory (electrically erasable programmable read-only memory), registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the embodiments described herein can be implemented in different systems without departing from the scope of the disclosure. It should be noted that the foregoing embodiments are merely examples and are not to be construed as limiting the disclosure. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method, comprising:
defining a plurality of memory access tags;
defining a plurality of read and write instructions that are specific to each memory access tag; and
defining, during compilation of a source code to an executable code, one or more memory blocks for the plurality of read and/or write instructions and associating one or more memory blocks with a corresponding memory access tag, where each memory block is only accessible by a read and/or write instruction associated with a same corresponding memory access tag.

2. The method of claim 1, wherein the plurality of memory access tags include three or more distinct types of memory access tags.

3. The method of claim 1, wherein each read and/or write instruction, in the plurality of read and/or write instructions, is associated with a distinct memory access tag.

4. The method of claim 1, wherein defining the plurality of distinct read and write instructions includes:
defining a first read and/or write instruction associated with a first memory access tag;
defining a second read and/or write instruction associated with a second memory access tag;
wherein the first read and/or write instruction fails to operate on a memory block associated with the second access tag.

5. The method of claim 4, wherein the first memory access tag is associated with a plurality of memory blocks.

6. The method of claim 1, wherein a memory block is a sub-page size memory region.

7. The method of claim 1, wherein the one or more memory blocks may be defined within a memory stack region or a memory heap region.

8. A non-transitory machine-readable storage medium having one or more instructions which when executed by a processing circuit causes the processing circuit to:
define a plurality of memory access tags;
define a plurality of read and write instructions that are specific to each memory access tag; and
define, during compilation of a source code to an executable code, one or more memory blocks for the plurality of read and/or write instructions and associating one or more memory blocks with a corresponding memory access tag, where each memory block is only accessible by a read and/or write instruction associated with a same corresponding memory access tag.

9. A method, comprising:
obtaining an executable code from a storage device, the executable code including a plurality of distinct read and write instructions where each read and/or write instruction is associated with one memory access tag from a plurality of distinct memory access tags;
defining one or more memory blocks in which each memory block is associated with one of the plurality of distinct memory access tags; and
executing at least some of the plurality of distinct read and/or write instructions in the executable code, where each executed read and/or write instruction is restricted to only access a memory block associated with the same memory access tag as the executed read and/or write instruction.

10. The method of claim 9, wherein if a read and/or write instruction attempts to access a memory block associated with a different memory access tag than the read and/or write instruction, then execution of the read and/or write instruction is inhibited or aborted.

11. The method of claim 9, wherein a memory block is a sub-page size memory region.

12. The method of claim 9, wherein the executable code is for a single application or process.

13. The method of claim 9, wherein the plurality of distinct read and write instructions includes:
a first read and/or write instruction associated with a first memory access tag; and
a second read and/or write instruction associated with a second memory access tag;
wherein the first read and/or write instruction is inhibited or aborted if it attempts to access a memory block associated with the second access tag.

14. The method of claim 9, wherein the one or more memory blocks are pre-defined when the executable is compiled or dynamically defined when the executable code is executed.

15. A device, comprising:
a storage device storing an executable code, the executable code including a plurality of distinct read and write instructions where each read and/or write instruction is associated with one memory access tag from a plurality of distinct memory access tags;
a processing circuit coupled to the storage device, the processing circuit configured to:
define one or more memory blocks in which each memory block is associated with one of the plurality of distinct memory access tags; and
execute at least some of the plurality of distinct read and/or write instructions in the executable code, where each executed read and/or write instruction is restricted to only access a memory block associated with the same memory access tag as the executed read and/or write instruction.

16. A device, comprising:
means for obtaining an executable code from a storage device, the executable code including a plurality of distinct read and write instructions where each read and/or write instruction is associated with one memory access tag from a plurality of distinct memory access tags;
means for defining one or more memory blocks in which each memory block is associated with one of the plurality of distinct memory access tags; and
means for executing at least some of the plurality of distinct read and/or write instructions in the executable code, where each executed read and/or write instruction is restricted to only access a memory block associated with the same memory access tag as the executed read and/or write instruction.

17. A non-transitory machine-readable storage medium having one or more instructions which when executed by a processing circuit causes the processing circuit to:
obtain executable code from a storage device, the executable code including a plurality of distinct read and write instructions where each read and/or write instruction is associated with one memory access tag from a plurality of distinct memory access tags;
define one or more memory blocks in which each memory block is associated with one of the plurality of distinct memory access tags; and
execute at least some of the plurality of distinct read and/or write instructions in the executable code, where each executed read and/or write instruction is restricted to only access a memory block associated with the same memory access tag as the executed read and/or write instruction.

18. A method, comprising:
obtaining an executable code from a storage device, the executable code including a plurality of distinct read and write instructions where each read and/or write instruction is specific to one memory access tag from a plurality of different memory access tags;
obtaining, from the executable code, a first read and/or write instruction associated with a first memory access tag; and
inhibiting execution of the first read and/or write instruction if the first read and/or write instruction attempts to access a memory block associated with a different memory access tag.

19. The method of claim 18, further comprising:
ascertaining that the first read and/or write instruction is associated with the first memory access tag.

20. The method of claim 18, further comprising:
ascertaining if the first read and/or write instruction seeks to access a memory block associated with a second memory access tag.

21. The method of claim 18, further comprising:
maintaining a mapping that defines a memory access tag for each of a plurality of memory blocks.

22. The method of claim 18, wherein the plurality of different memory access tags include three or more distinct types of memory access tags.

23. The method of claim 18, wherein the first memory access tag is associated with a plurality of distinct memory blocks, where the plurality of distinct memory blocks are all associated with the same memory access tag.

24. The method of claim 18, wherein a memory block is a sub-page size memory region.

25. A device, comprising:
a storage device storing an executable code, the executable code including a plurality of distinct read and write instructions where each read and/or write instruction is specific to one memory access tag from a plurality of different memory access tags;
a processing circuit coupled to the storage device, the processing circuit configured to:
obtain, from the executable code, a first read and/or write instruction associated with a first memory access tag; and
inhibit execution of the first read and/or write instruction if the first read and/or write instruction attempts to access a memory block associated with a different memory access tag.

26. The device of claim 25, wherein the processing circuit is further configured to:
ascertain that the first read and/or write instruction is associated with the first memory access tag.

27. The device of claim 25, wherein the processing circuit is further configured to:
ascertain if the first read and/or write instruction seeks to access a memory block associated with a second memory access tag.

28. The device of claim 25, wherein the processing circuit is further configured to:
maintain a mapping, in a memory device, that defines a memory access tag for each of a plurality of memory blocks.

29. The device of claim 25, wherein the plurality of different memory access tags includes three or more distinct types of memory access tags.

30. The device of claim 25, wherein the first memory access tag is associated with a plurality of distinct memory blocks, where the plurality of distinct memory blocks are all associated with the same memory access tag.

31. The device of claim 25, wherein a memory block is a sub-page size memory region.

32. A device, comprising:
means for obtaining an executable code from a storage device, the executable code including a plurality of distinct read and write instructions where each read and/or write instruction is specific to one memory access tag from a plurality of different memory access tags;
means for obtaining, from the executable code, a first read and/or write instruction associated with a first memory access tag; and
means for inhibiting execution of the first read and/or write instruction if the first read and/or write instruction attempts to access a memory block associated with a different memory access tag.

33. A non-transitory machine-readable storage medium for protecting memory blocks from unauthorized access, the machine-readable storage medium having one or more instructions which when executed by a processing circuit causes the processing circuit to:
obtain executable code from a storage device, the executable code including a plurality of distinct read and write instructions where each read and/or write instruction is specific to one memory access tag from a plurality of different memory access tags;
obtain, from the executable code, a first read and/or write instruction associated with a first memory access tag; and
inhibit execution of the first read and/or write instruction if the first read and/or write instruction attempts to access a memory block associated with a different memory access tag.

34. The non-transitory machine-readable storage medium of claim 33, the machine-readable storage medium further having one or more instructions which when executed by a processing circuit causes the processing circuit to:
maintain a mapping, in a memory device, that defines a memory access tag for each of a plurality of memory blocks.

35. The non-transitory machine-readable storage medium of claim 33, the machine-readable storage medium further having one or more instructions which when executed by a processing circuit causes the processing circuit to:
ascertain that the first read and/or write instruction is associated with the first memory access tag.
